(19) United States
(12) Patent Application Publication
(10) Pub. No.: US 2017/0075533 A1
(43) Pub. Date: Mar. 16, 2017

(54) SCROLLING DIGITAL CONTENT WITH AUTO-ALIGNING

(71) Applicant: Flipboard, Inc., Palo Alto, CA (US)

(72) Inventor: Raphael Mauro Schaad, Cambridge, MA (US)

(21) Appl. No.: 14/855,114

(22) Filed: Sep. 15, 2015

(51) Int. Cl. G06F 3/0485

(52) U.S. Cl. CPC G06F 3/0485

(57) ABSTRACT

A solution is provided for presenting content items of a digital magazine to a user of a digital magazine server, where a slide operation is performed with auto-aligning feature that allows an edge of a content item to be aligned with a predetermined snap location. In one aspect, the auto-aligning feature is performed by determining friction that allows the slide operation to conclude with an edge of a content item aligned with the predetermined snap location, based on a prediction of a slide operation with default friction applied, and applying the determined friction to execute the slide operation. In another aspect, the auto-aligning feature is performed by executing the slide operation with the default friction and shifting the content items such that an edge of a content item is aligned with the snap position.

### BACKGROUND

The disclosure generally relates to the field of user interface controls in a digital magazine, and more specifically to scrolling content items with auto-aligning in the digital magazine.

Digital distribution channels disseminate a wide variety of digital content including text, images, audio, links, videos, and interactive media (e.g., games, collaborative content) to users. Recent development of mobile computing devices such as personal computers, smart phones, tablets, etc., enables users to access numerous content items in various forms. In one example user interface, various content items (e.g., sports reports, finance news, fashion articles, etc.) of a digital magazine may be disposed on a content panel of the digital magazine that may be larger than a display of a client device, and only a portion of the content panel is displayed to a user. For the user to access the content items hidden or not displayed, the user can scroll the content panel to explore other portions of the content panel and locate a desired content item. However, even after locating the desired content item, the content panel may be positioned such that a portion of the desired content item may be hidden or a content item adjacent to the desired content item is displayed. Hence, a user may need to reposition the content panel such that a desired portion of the content panel is displayed. As a result, it may be inconvenient for a user to identify a desired content and consume the identified content item among other content items.

### SUMMARY

A computer-implemented method is disclosed for presenting content items to a user through a user interface of a digital magazine, in which an edge of a selected content item is aligned with a predetermined snap position. Embodiments of the method comprise executing a slide operation of a content panel, where multiple content items of the digital magazine can be arranged. Upon detecting the slide operation, default friction applied to the slide operation is obtained. If the slide operation was concluded according to the default friction applied, some of edges of content items may not be aligned with the predetermined snap position. In one aspect, an edge of a content item to be aligned with the predetermined snap position is determined prior to executing the slide operation, based on a prediction of the slide operation executed according to the default friction applied. The friction to be applied to the slide operation is determined such that the determined edge can be seamlessly aligned with the predetermined snap position after the slide operation ends. The slide operation is executed according to the determined friction.

Different embodiments of the method comprise executing a slide operation of a content panel, and repositioning the content panel after the slide operation is executed such that an edge is aligned with the predetermined snap position. In one aspect, upon detecting the slide operation, default friction applied to the slide operation is obtained, and the slide operation is executed according to the default friction. After the slide operation is executed according to the default friction, some of edges of content items may not be aligned with the predetermined snap position. After the slide operation stops, an edge of a content item to be aligned with the predetermined snap position is determined, and the content panel is shifted such that the determined edge is aligned with the predetermined snap position.

Another aspect provides a non-transitory computer-readable storage medium storing executable computer program instructions for presenting content items of a digital magazine in which the slide operation concludes with an edge of a selected content item aligned with the predetermined snap position. The computer-readable storage medium stores computer program instructions comprising instructions for detecting a slide operation, obtaining default friction applied to the slide operation, determining an edge of a content item to be aligned with the predetermined snap position based on the predicted slide operation with default friction, and determining the friction applied to the slide operation such that the determined edge is smoothly (or seamlessly) aligned with the predetermined snap position when the slide operation is finished.

Another aspect provides a non-transitory computer-readable storage medium storing executable computer program instructions for presenting content items of a digital magazine in which the slide operation concludes with an edge of a content item aligned with the predetermined snap position. The computer-readable storage medium stores computer program instructions comprising instructions for detecting the slide operation a slide operation, obtaining default friction applied to the slide operation, executing the slide operation according to the default friction, determining an edge of a content item to be aligned with the predetermined snap position, and shifting the content panel such that the determined edge is aligned with the predetermined snap position.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a block diagram of a system environment for organizing and sharing content via a digital magazine according to one embodiment.

FIG. 2 is an example of a content browse page of a digital magazine according to one embodiment.

FIG. 3A is a block diagram illustrating a digital magazine server according to one embodiment.

FIG. 3B is a block diagram illustrating a client device according to one embodiment.

FIG. 4A is a block diagram illustrating an input execution module of the client device illustrated in FIG. 3B according to one embodiment.

FIG. 4B is a block diagram illustrating a content panel controller of the client device illustrated in FIG. 3B according to one embodiment.

FIG. 5A illustrates an example user interface of a client device with a content panel before a slide operation is executed according to one embodiment.

FIG. 5B illustrates an example user interface of the client device with the content panel after the slide operation without an auto-aligning feature being performed on the content panel shown in FIG. 5A according to one embodiment.

FIG. 5C illustrates an example user interface of the client device with the content panel after the slide operation with the auto-aligning feature being performed on the content panel shown in FIG. 5A according to one embodiment.

FIG. 5D illustrates an example user interface of a client device with a content panel before a slide operation is executed according to one embodiment.

FIG. 5E illustrates another example user interface of the client device with the content panel after the slide operation without an auto-aligning feature being performed on the content panel shown in FIG. 5D according to one embodiment.

FIG. 5F illustrates another example user interface of the client device with the content panel after the slide operation with the auto-aligning feature being performed on the content panel shown in FIG. 5D according to one embodiment.

FIG. 6 is a flow chart illustrating a process for determining whether to enable the auto-aligning feature for a slide operation according to one embodiment.

FIG. 7A is a flow chart illustrating a process for aligning an edge of the content item with a display screen for a slide operation according to one embodiment.

FIG. 7B is a flow chart illustrating a process for aligning an edge of the content item with a display screen for a slide operation according to another embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### Configuration Overview

One embodiment of a disclosed configuration is a system (or a computer implemented method or a non-transitory computer readable medium) for presenting content items to a user through a user interface of a digital magazine, in which an edge of a selected content item is aligned to a predetermined snap position. A “content item” herein refers to any machine-readable and machine-storable work product, such as text, image, video, audio, or a combination of thereof. A “digital magazine” herein refers to an aggregation of digital content items that can be presented to users in a presentable format similar to the format used by print magazines. The user interface enables a user to scroll a content panel of the digital magazine, in which content items are arranged, to locate a desired content item. In one aspect, the user interface executes a scrolling operation (herein also referred to as a “sliding operation” or a “slide operation”) with an auto-aligning feature that snaps an edge of a selected content item to a predetermined snap position to complete the scrolling operation. The predetermined snap position is a coordinate, a line or an area of a display with which an edge of the content item can be aligned.

In one embodiment, an edge of a content item is aligned with a predetermined snap position. Whether to enable the auto-aligning feature of the user interface depends on the velocity of the scrolling action when the user lifts a pointer (e.g., his/her finger). If the velocity of the scrolling action is below or equal to a threshold, the auto-aligning feature is disabled. If the velocity of the scrolling action is above a threshold, the auto-aligning feature is enabled.

In one embodiment of the auto-aligning feature, the slide operation is performed according to a prediction of a slide operation with default friction applied to the slide operation. The default friction can be obtained based on, for example, the velocity of the scrolling action when the user lifts a pointer. A prediction of a slide operation with default friction applied to the slide operation is obtained, and based on the prediction, a target edge to be aligned with the snap position is determined. Moreover, friction to apply to the slide operation is determined to smoothly align the determined target edge with the snap position. The slide operation is executed according to the determined friction, and the slide operation concludes with the determined target edge smoothly aligned with the snap position.

In another embodiment of the auto-aligning feature, the slide operation is performed according to the default friction, and after the slide operation stops, the content panel is shifted such that an edge of a content item is aligned to the snap position. Scrolling content items with auto-aligning advantageously allows a user to access content items via a client device in a format that enhances the user's interaction with and consumption of the content items. For example, by snapping an edge of the content item to a predetermined snap position through the slide operation with auto-aligning feature, the user may view the content item without adjusting the position of the content panel after the slide operation.

### Example Digital Magazine System Environment

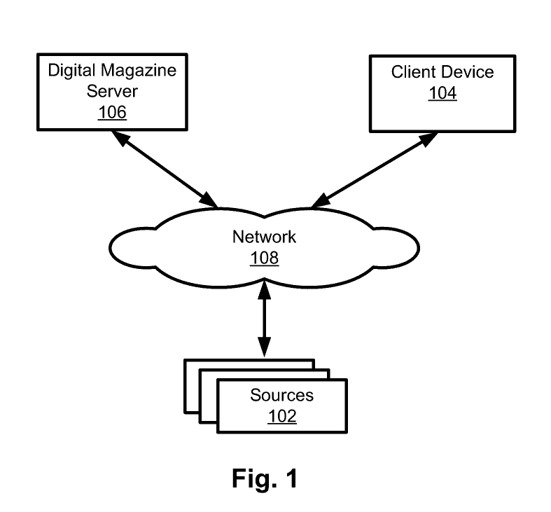

FIG. 1 is a block diagram of a system environment 100 for organizing and presenting content items via a digital magazine to a user of the digital magazine according to one embodiment. The system environment 100 shown in FIG. 1 includes one or more source devices 102, a network 108, a client device 104, and a digital magazine server 106. In alternative embodiments, different and/or additional components may be included in the system environment 100.

A source device 102 is a computing system capable of providing various types of content to a client device 104. Examples of content provided by a source device 102 include text, images, video, or audio on web pages, web feeds, social networking information, messages, or other suitable data. Additional examples of content include user-generated content such as blogs, tweets, shared images, video or audio, social networking posts, and social networking status updates. Content (e.g., stories about news events, product information, entertainment, or educational material) provided by a source device 102 may be received from a publisher and distributed by the source device 102. For convenience, content from a source device, regardless of its composition, may be referred to herein as an “article,” a “content item,” or as “content.” A content item may include various types of content, such as text, images, and video.

The source devices 102, the digital magazine server 106 and the client device 104 communicate among each other through the network 108. The network 108 may comprise any combination of local area and/or wide area networks, using both wired and/or wireless communication systems. In one embodiment, the network 108 uses standard communications technologies and/or protocols. For example, the network 108 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 108 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 108 may be represented using any suitable format, such as hypertext markup language (HTML) or extensible markup language (XML). In some embodiments, all or some of the communication links of the network 108 may be encrypted using any suitable technique or techniques.

The client device 104 is a computing device capable of receiving user input as well as transmitting and/or receiving data via the network 108. In one embodiment, the client device 104 is a conventional computer system, such as a desktop or a laptop computer. Alternatively, the client device 104 may be a device having computer functionality, such as a personal digital assistant (PDA), a mobile telephone, a smartphone or another suitable device. In one embodiment, the client device 104 executes a program (or an application) allowing a user of the client device 104 to interact with the digital magazine server 106 through the network 108. For example, an application executing on the client device 104 communicates instructions or requests for content items to the digital magazine server 106 to modify content presented to a user of the client device 104. As another example, the client device 104 executes a browser that receives pages from the digital magazine server 106 and presents the pages to a user of the client device 104. While FIG. 1 shows a single client device 104 for simplicity, in various embodiments, any number of client devices 104 may communicate with the digital magazine server 106.

The digital magazine server 106 receives content items from one or more source devices 102, generates pages in a digital magazine by processing the received content items, and serves the pages to users of the client device 104. To provide content items to a user, the digital magazine server 106 generates one or more pages for presentation to a user based on content items obtained from one or more source devices 102 and information describing organization and presentation of content items. For example, the digital magazine server 106 determines a page layout including various content items based on information associated with a user and generates a page including the content items arranged according to the determined layout for presentation to the user via the client device 104.

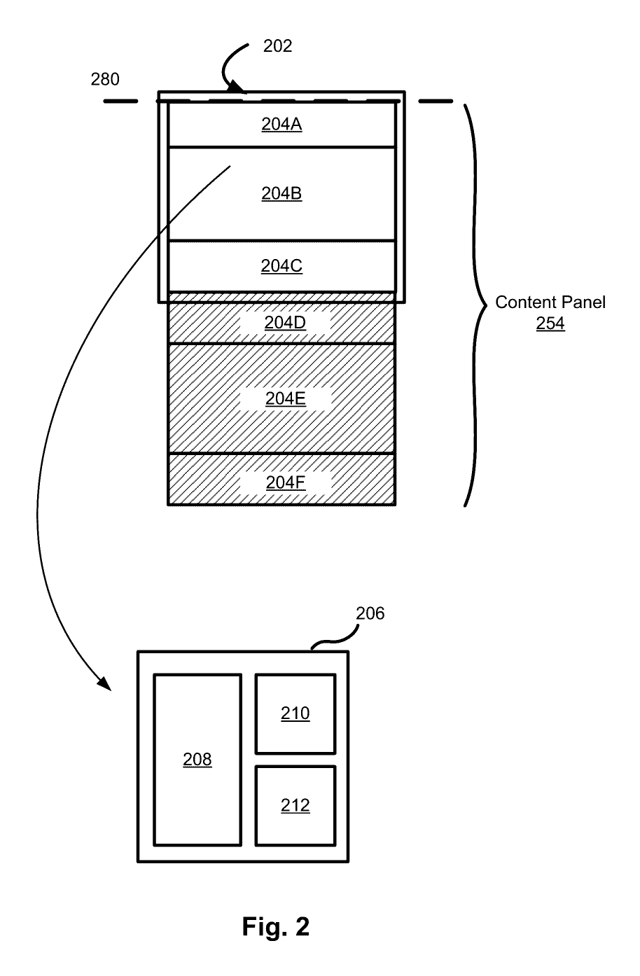

In FIG. 2, an example of a content browse page 202 of a digital magazine is illustrated according to one embodiment. In one embodiment, the digital magazine server 106 may generate the content browse page 202, and transmit the content browse page 202 to the client device 104 for presentation at the client device 104. Alternatively, the digital magazine server 106 instructs the client device 104 to execute a corresponding digital magazine application, which generates the content browse page 202. In one embodiment, the content browse page 202 includes a content panel 254. The content items 204A . . . 204F (generally herein referred to as a “content item 204”) are arranged in the content panel 254, where a portion of the content panel 254 may be displayed at the client device 104 and another portion of the content panel 254 may be hidden from being viewed by a user of the content browse page 202.

The content panel 254 is an area of the content browse page 202 for presenting content items 204 to a user. In one embodiment, the content panel 254 is divided into multiple sections, each of which is assigned to a corresponding content item 204. For example, a first section is allocated for the content item 204A presenting sports reports, a second section is allocated for the content item 204B presenting cooking recipes, and a third section is allocated for the content item 204C presenting fashion articles. The content items 204 may be arranged in a linear arrangement. Alternatively, the content items 204 are arranged in multi-dimensions array (e.g., two or three dimensions).

In one embodiment, one or more content items 204 in the content panel 254 are displayed on a display of the client device 104, while other content items 204 are hidden. In the example illustrated in FIG. 2, three content items 204A, 204B, 204C are currently displayed on the content panel 254, and content items 204D, 204E, 204F are hidden from being viewed by a user of the content browse page 202.

When a content item 204, e.g., content item 204B, is selected by a user of the client device 104, a content page 206 associated with the content item 204B is presented at the client device 104. The content page 206 may include multiple sub-content items 208, 210, and 212. The content page 206 may have a layout in a similar arrangement but in a different size or ratio compared to the layout of the corresponding content item 204B presented on the content browse page 202. Alternatively, the content page 206 may have a layout in different arrangement compared to the layout of the corresponding content item 204B presented on the content browse page 202.

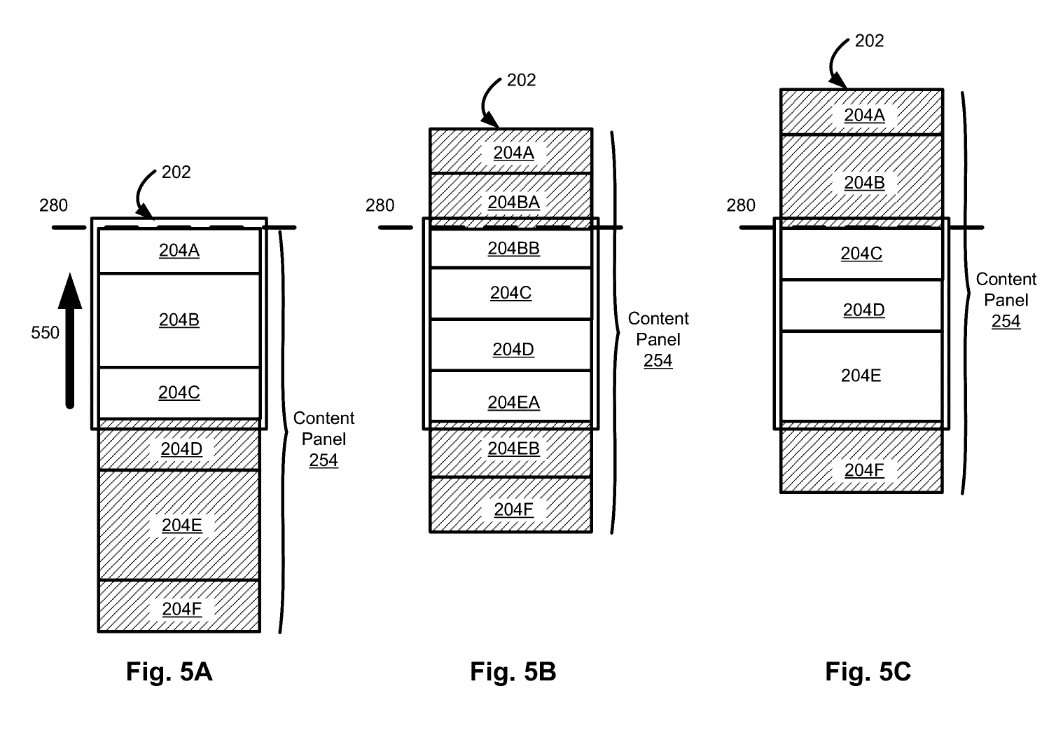

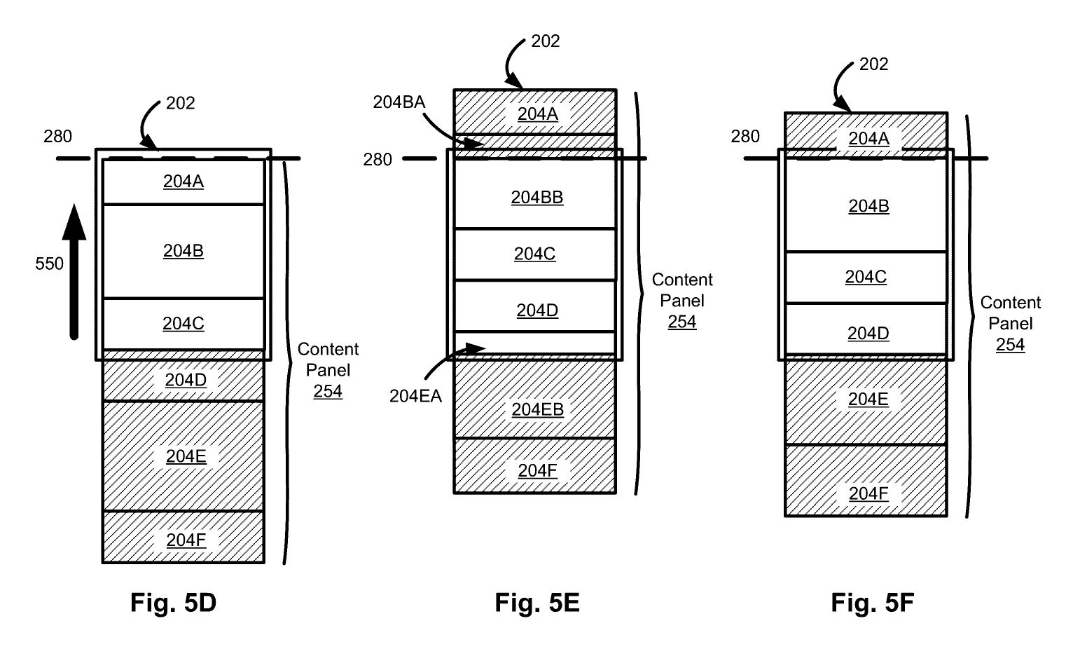

The content panel 254 can be slid, dragged, relocated, or resized according to a user input such that position of the display region of the content panel 254 can be dynamically changed in response to the user input. Hence, content items 204 displayed on the content panel 254 may be changed according to the user input. Scrolling content items with auto-aligning allows a user to access content items via the client device 104 in a format that enhances the user's interaction with and consumption of the content items. For example, the client device 104 aligns an edge of a selected content item with a snap position 280. When a user slides the content panel 254, the client device 104 applies friction to a slide operation such that an edge of a content item 204 is aligned (or snapped) with the snap position 280 smoothly. Hence, a user may consume the content item after the slide operation concludes without adjusting the position of the content panel. Details of scrolling content items with auto-aligning are further described below with reference to FIGS. 5A-5F.

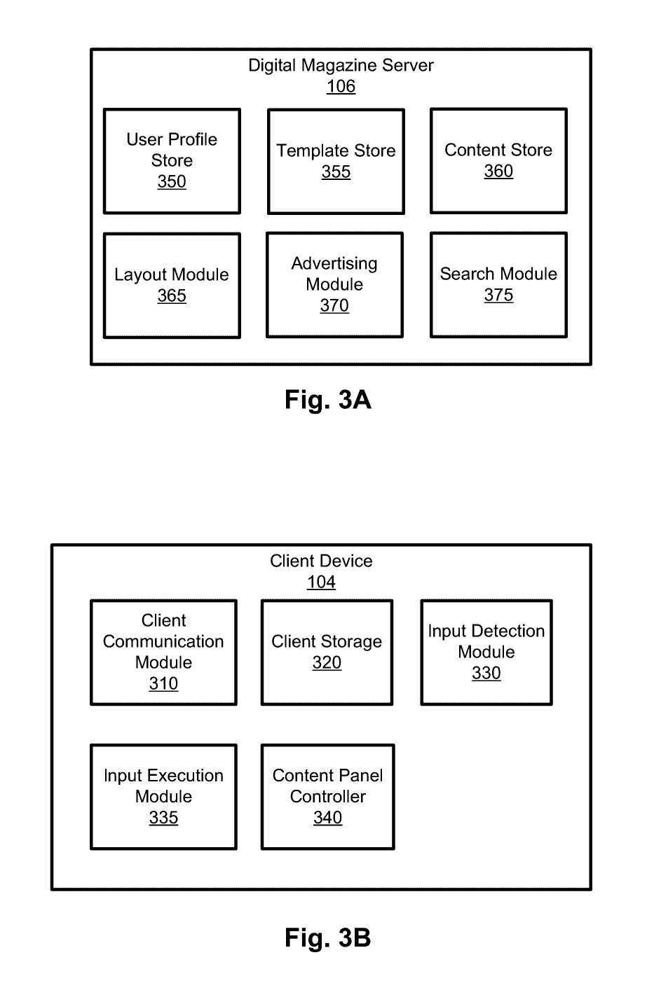

FIG. 3A is a block diagram illustrating a digital magazine server 106 according to one embodiment. In one embodiment, the digital magazine server 106 includes a user profile store 350, a template store 355, a content store 360, a layout module 365, an advertising module 370, and a search module 375. These components operate together to generate content pages according to selected page layouts and transmit the generated content pages to the client device 104 for presentation. In other embodiments, the digital magazine server 106 may include different, fewer, or additional components.

The user profile store 350 stores user profiles. A user profile includes information about the user that was explicitly shared by the user and may also include profile information inferred by the digital magazine server 106. In one embodiment, a user profile includes multiple data fields, each describing one or more attributes of the corresponding digital magazine server user. Examples of information stored in a user profile include biographic, demographic, and other types of descriptive information, such as gender, hobbies or preferences, location, data describing interactions by a corresponding user with content items presented by the digital magazine server 106, or other suitable information.

The template store 355 includes layout (herein also referred to as “page templates”) each describing a spatial arrangement of content items relative to each other on a section for presentation by a client device 104. Each section has a size (e.g., small, medium, or large) and an aspect ratio. One or more page templates may be associated with types of client devices 104, allowing content items to be presented in different relative locations and with different sizes when the content items are viewed using different client devices 104. Additionally, page templates may be associated with source devices 102, allowing a source device 102 to specify the format of sections presenting content items received from the source device 102.

In various embodiments, page templates included in the template store 355 may be defined with flexible dimensions, allowing presentation of content items to account for various sizes or dimensions of a display area in which the content items are presented. For example, a page template includes display regions specifying a percentage of a display area in which a content item is presented.

The content store 360 stores various types of digital content from the source devices 102. Examples of content items stored by the content store 360 include a page post, a status update, a photograph, a video, a link, an article, a photograph, video data, and any other type of digital content.

The layout module 365 retrieves content items from one or more source devices 102 or from the content store 360 and generates a page including the content items based on a page template from the template store 355. For example, the layout module 365 selects a page template based on previously-selected templates and/or characteristics of the content items. The layout module 365 may associate the content item with a section configured to present a specific type of content item or to present content items having one or more specified characteristics.

The advertising module 370 facilitates source devices 102 or other vendors to present advertisements to a user of the client device 104. A source device 102 may provide advertisements for their products or services. An advertisement of a product or a service may be arranged in a page transmitted to the client device 104. In one approach, the advertising module 370 analyzes user preferences or history of content items being viewed by a user of the client device 104, determines a product or a service that the user is likely to be interested in, and includes the advertisement corresponding to the determined product or service in the page for transmission to the client device 104. In another approach, the advertising module 370 identifies an advertisement related to a content item displayed, and includes the identified advertisement in the page for transmission to the client device 104.

The search module 375 receives a search query from a user through the client device 104 and retrieves content items from one or more source devices 102 or from the content store 360 based on the search query. For example, content items having at least a portion of an attribute matching at least a portion of a search query are retrieved from one or more source devices 102. In one embodiment, the search module 375 generates a section of the digital magazine including the content items identified based on the search query.

FIG. 3B is a block diagram of a client device 104 according to one embodiment. In the embodiment illustrated in FIG. 3B, the client device 104 includes a client communication module 310, a client storage 320, an input detection module 330, an input execution module 335, and a content panel controller 340. These components operate together to present content items in digital magazine pages to a user of the client device 104. For example, the input detection module 330 detects an input operation based on user interaction with the client device 104, and provides the detected input operation to the input execution module 335 for execution. The content panel controller 340 provides an initial image of a display panel for displaying content items and an update image of the content panel of the client device 104 according to the input operation executed by the input execution module 335. In other embodiments, the client device 104 may include different, fewer, or additional components.

The client communication module 310 is a communication interface between the client device 104 and the network 108. The client device 104 can exchange data with the source devices 102 and/or the digital magazine server 106 through the client communication module 310. The client communication module 310 may receive pages from the digital magazine server 106 for presenting content items (and advertisements) to a user of the client device 104. Moreover, the client communication module 310 receives a user input on changes to content items displayed, page layouts and user feedback, and transmits the user input to the digital magazine server 106 for further processing.

The client storage 320 is a repository for storing data generated and received by the client device 104. For example, the client storage 320 stores information for presenting content pages and content items of a digital magazine to a user of the client device 104. Other data stored at the client storage 320 includes browsing history, search history, user preference, and data access information and authorization to the digital magazine server 106.

The input detection module 330 receives an input signal obtained from an input device (e.g., pointing device or a keyboard) coupled to the client device 104 or an input device (e.g., touch screen) embedded in the client device 104, and determines an input operation associated with the input signal. The input detection module 330 analyzes series or parallel input signals received at the input device to determine the details of the input operation. Specifically, the input detection module 330 determines a type of input operation (e.g., slide operation, drag operation, etc.) and attributes associated with the determined input operation, e.g., direction and velocity of the operation. In one implementation, the input detection module 330 determines the input is a selection operation in response to a mouse button being pressed or a touch screen being touched (by a finger or a stylus pen). The input detection module 330 determines the input is a release operation in response to a mouse button being released or a touch screen being untouched from a selection operation.

The input detection module 330 determines a slide operation based on user interaction with the client device 104. For example, if a release operation is detected and a change in the coordinate of an area to be released occurred within the predetermined time period (e.g., 2 seconds) before the end of the release operation, the input detection module 330 determines the input operation is a slide operation. Accordingly, if a user's touch was detected at a coordinate for at least the predetermined time period before the release operation, the input detection module 330 determines the input operation is not a slide operation.

The input detection module 330 further determines a direction of the slide operation and a velocity of the slide operation based on the change in the coordinate before the release operation. In one aspect, the input detection module 330 compares the determined velocity with a velocity threshold. Responsive to the determined velocity being less than the velocity threshold, the input detection module 330 flags that the auto-aligning feature is not applied to the slide operation. Responsive to the determined velocity being greater than or equal to the velocity threshold, the input detection module 330 flags that the auto-aligning feature is applied to the slide operation and provides the attributes associated with the slide operation, e.g., the direction and velocity of the slide, to the input execution module 335 for further processing.

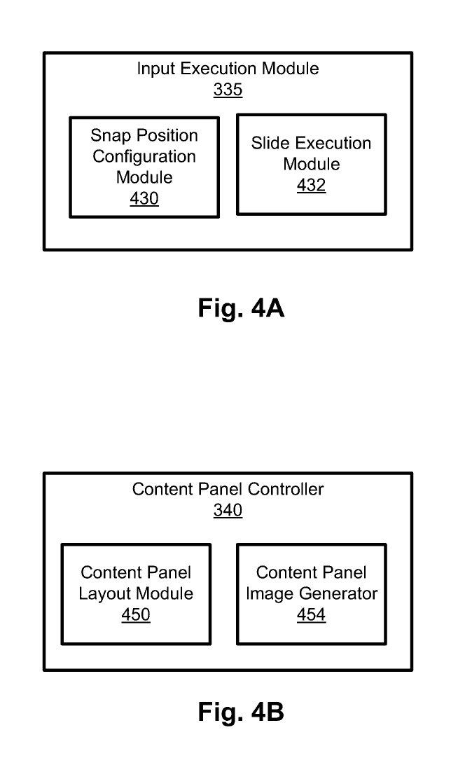

The input execution module 335 receives the determined input operation from the input detection module 330 and executes the input operation, and the content panel controller 340 provides an updated image of the content panel according to the input operation executed. One embodiment of the input execution module 335 is further described below with reference to FIG. 4A, and one embodiment of the content panel controller 340 is further described below with reference to FIG. 4B.

FIG. 4A is a block diagram of the input execution module 335 according to one embodiment. The input execution module 335 receives the input operation and attributes associated with the input operation (e.g., a type of input operation, direction, velocity, duration, etc.) from the input detection module 330 and executes the input operation. In the embodiment illustrated in FIG. 4A, the input execution module 335 includes a snap position configuration module 430, and a slide execution module 432. In alternative configurations, different and/or additional components may be included in the input execution module 335.

The snap position configuration module 430 determines a snap position on a content browse page, in which an edge of a content item is snapped to or aligned with. Taking FIG. 2 as an example, the snap position configuration module 430 determines the snap position 280 on the content browse page 202, where an edge of one of the content items 204A-204F, e.g., content item 204A, is aligned with the snap position 280 responsive to a slide operation applied to the content panel 254. The snap position 280 may comprise a single coordinate, a single line or an area. In one embodiment, the snap position 280 is located on a display region of the content panel. Alternatively, the snap position 280 is located outside of the display region of the content panel. The snap position 280 can be predetermined by the snap position configuration module 430, and can be adjusted based on user input.

The slide execution module 432 receives attributes, e.g., a slide direction and velocity, regarding a slide operation from the input detection module 330 and executes the slide operation. The slide execution module 432 also receives from the content panel controller 340 coordination information of an initial image of a content panel, e.g., the content panel 254 in FIG. 2, where the coordination information indicates a position of a display region of the content panel 254.

In one embodiment, the slide execution module 432 determines whether to apply auto-aligning feature based on a velocity of the slide operation obtained from the input detection module 330. In one aspect, in response to the velocity of the slide operation not exceeding the velocity threshold, the slide execution module 432 disables the auto-aligning feature. In response to the velocity of the slide operation exceeding the velocity threshold, the slide execution module 432 enables the auto-aligning feature such that an edge of a content item is aligned with the snap position 280.

In one embodiment, the slide execution module 432 determines default friction applied to the slide operation. In one approach, the default friction is determined based on the position of the display region, direction and velocity of a slide operation. For example, the default friction may be proportional to a velocity of the slide operation. The default friction is applied to the slide operation, if the auto-aligning feature is disabled. However, an edge of a content item may not be aligned with the snap position, if the slide operation is executed with the default friction. If the auto-aligning feature is enabled, the default friction can be used to estimate friction to apply to the slide operation, such that an edge of a content item is aligned with the snap position.

In one embodiment for performing auto-aligning feature, the slide execution module 432 estimates friction to be applied to the slide operation such that an edge of the content item is seamlessly aligned with the snap position 280. In one aspect, the slide execution module 432 predicts a slide operation with default friction applied, and determines a content item on which the snap position will be located according to the predicted slide operation. Furthermore, the slide execution module 432 determines a target edge (e.g., an edge of a content item to be aligned with the snap position 280). The target edge may be an edge between two content items, which is closer to the snap position 280 than another an edge between another two content items or an edge appearing before or after the snap position 280 in the sliding direction of the content panel 254 when the predicted slide operation with the default friction is ended. Moreover, the slide execution module 432 determines friction to be applied to the slide operation, for example, based on the current position of the display region, velocity, and the remaining distance between the target edge and the snap position. The slide operation executed with the determined friction enables an edge of a content item to be smoothly aligned with the snap position 280.

In another embodiment for performing auto-aligning feature, the slide execution module 432 executes the slide operation with the default friction, and shifts the content panel if needed after the slide operation stops. As described above, after the slide operation is executed according to the default friction, some of edges may not be aligned with the snap position. After the slide operation stops, the slide execution module 432 determines a target edge (e.g., an edge of a content item to be aligned with the snap position 280). The target edge may be an edge between two content items, which is closer to the snap position 280 than another an edge between another two content items or an edge appearing before or after the snap position 280 in the sliding direction of the content panel 254 after the slide operation stops. The slide execution module 432 shifts the content panel such that the determined target edge is aligned with the snap position 280.

The slide execution module 432 executes the slide operation by providing a position of the display region on a content panel to the content panel controller 340. The slide execution module 432 determines a position of the display region of the content panel 254 at a specific time according to the slide operation. The slide execution module 432 repeatedly updates the position of the display region of the content panel 254 until the slide operation is concluded.

FIG. 4B is a block diagram of the content panel controller 340 according to one embodiment. The content panel controller 340 generates a content page having a display region of a content panel, e.g., the content panel 254 shown in FIG. 2. In one embodiment, the content panel controller 340 includes a content panel layout module 450, and a content panel image generator 454. In alternative embodiments, different and/or additional components may be included in the content panel controller 340.

The content panel layout module 450 receives a page template from the client storage 320 or the template store 355 of the digital magazine server 106 through the client communication module 310. The page template has information describing arrangement of content items to be displayed in a content panel. Taking the content panel 254 shown in FIG. 2 as an example, the content panel layout module 450 obtains a list of content items to be included in the content panel 254, size, shape, location of each section of the content panel 254, and association between each content and a section in the content panel 254 from the page template. The content panel layout module 450 can modify the layout of the content panel 254 described by the received page template in a format suitable for presentation on the client device 104.

The content panel image generator 454 generates an image of the display region of the content panel 254 based on a position of the content panel 254 indicated by the input execution module 335 and based on the layout information of the content panel layout module 450. Specifically, the content panel image generator 454 determines which portion of the content panel 254 is to be displayed and which portion of the content panel 254 is to be hidden based on the position indicated by the slide execution module 432. Furthermore, the content panel image generator 454 generates an image of the display region of the content panel 254 according to the determined portion of the content panel 254. The image of the display region of the content panel 254 is provided to a display device (not shown) of the client device 104 for presentation. Example images of the display region of the content panel 254 are provided in FIGS. 5 through 5F.

### Exemplary Operation

FIG. 5A illustrates an example user interface of the client device 104 with the content panel 254 at an initial position, according to one embodiment. For simplicity, the arrangement of content items 204, and content panel 254 in FIG. 5A are the same as the ones described in FIG. 2. In FIG. 5A, three content items, 204A, 204B and 204C, are currently displayed in the content panel 254. A user of the client device 104 slides the content panel 254 along a direction 550. The slide operation is detected by the input detection module 330 and is executed by the input execution module 335. The content panel controller 340 generates an updated image of the display of the content panel 254 according to the slide operation executed.

FIG. 5B illustrates an example user interface of the client device 104 with the content panel 254 after the slide operation without the auto-aligning feature is performed on the content panel 254 shown in FIG. 5A, according to one embodiment. In one aspect, a content panel is predicted to be in a state as shown in FIG. 5B after the slide operation with the default friction is executed. Alternatively, a slide operation with the default friction is executed, and the slide operation stops as shown in FIG. 5B.

In FIG. 5B, the content panel 254 is shifted along the direction 550 with an edge of a content item being misaligned with a snap position 280, as shown in FIG. 5B. Specifically, the content item 204B is partitioned into two portions: a first portion 204BA and a second portion 204BB. In this example, the content item 204B was displayed before the slide operation; after the slide operation with the default friction or according to the predicted slide operation with the default friction, its first portion 204BA becomes hidden, where the second portion (e.g., 204BB) remains visible. In addition, the content item 204E was hidden before the slide operation: after the slide operation with the default friction or according to the predicted slide operation with the default friction, the first portion 204EA is now displayed, where a second portion of 204EB remains hidden. In this configuration, if the content item 204B contains a desired content, the user may have difficulty accessing the content item 204B, because the first portion 204BA hidden.

In one aspect, the slide execution module 432 determines a target edge to be aligned with the snap position 280 for performing auto-aligning feature. For example, the edge between the content item 204B and the content item 204C can be determined to be a target edge, because the snap position 280 is closer to an edge between the content item 204B and content item 204C than an edge between the content item 204A and content item 204B.

FIG. 5C illustrates an example user interface of the client device 104 with the content panel 254 after the slide operation with the auto-aligning feature being performed on the content panel shown in FIG. 5A, according to one embodiment. In FIG. 5C, a target edge (e.g., an edge between a content item 204B and a content item 204C) is aligned with the snap position 280. If the state of the content panel shown in FIG. 5B is a prediction of the slide operation with the default friction, the slide execution module 432 determines friction to apply to the slide operation such that slide operation smoothly concludes with the target edge (e.g., an edge between the content item 204B and the content item 204C) aligned with the snap position 280 as shown in FIG. 5C. If the state of the content panel shown in FIG. 5B is a state of the content panel after the slide operation with the default friction is applied, the slide execution module 432 shifts the content panel such that the target edge is aligned with the snap position 280 as shown in FIG. 5C.

FIG. 5D illustrates an example user interface of the client device 104 with the content panel 254 at an initial position, according to one embodiment. For simplicity, the arrangement of content items 204, and content panel 254 in FIG. 5A are the same as the ones described in FIG. 2 and FIG. 5A. Therefore, the detailed description thereof is omitted herein.

FIG. 5E illustrates another example user interface of the client device 104 with the content panel 254 after the slide operation without the auto-aligning feature being performed on the content panel shown in FIG. 5D, according to one embodiment. In one aspect, a content panel is predicted to be in a state as shown in FIG. 5E after the slide operation with the default friction is executed. Alternatively, a slide operation with the default friction is executed, and the slide operation stops as shown in FIG. 5E. The state of the content panel 254 in FIG. 5E is similar to the state of the content panel 254 in FIG. 5B, except the snap position 280 is closer to the edge between the content item 204A and content item 204B than an edge between the content item 204B and content item 204C.

FIG. 5F illustrates another example user interface of the client device with the content panel after the slide operation including the auto-aligning feature being performed on the content panel shown in FIG. 5D, according to one embodiment. The state of the content panel 254 in FIG. 5F is similar to the state of the content panel 254 in FIG. 5C, except the edge between the content item 204A and the content item 204B is aligned with the snap position 280. In FIG. 5F, the content items 204B, 204C and 204D are displayed where the content items 204A, 204E, and 204F are hidden.

Although in FIG. 5B or FIG. 5E, an edge closer to the snap position 280 is determined to be a target edge, in different embodiments, an edge appearing before or after the snap position 280 in the sliding direction of the content panel 254 may be determined to be the target edge.

By performing a slide operation with the auto-aligning feature disclosed herein, the user can view the content item, without having to adjust (e.g., drag) the position of the content panel to align an edge of the content item, for example, with the snap position 280 (e.g., display edge). Hence, a user can quickly identify and consume a desired content in the digital magazine without the cumbersome process of repositioning (e.g., dragging) the content panel to align the edge of the content item with the snap position 280.

### Exemplary Method

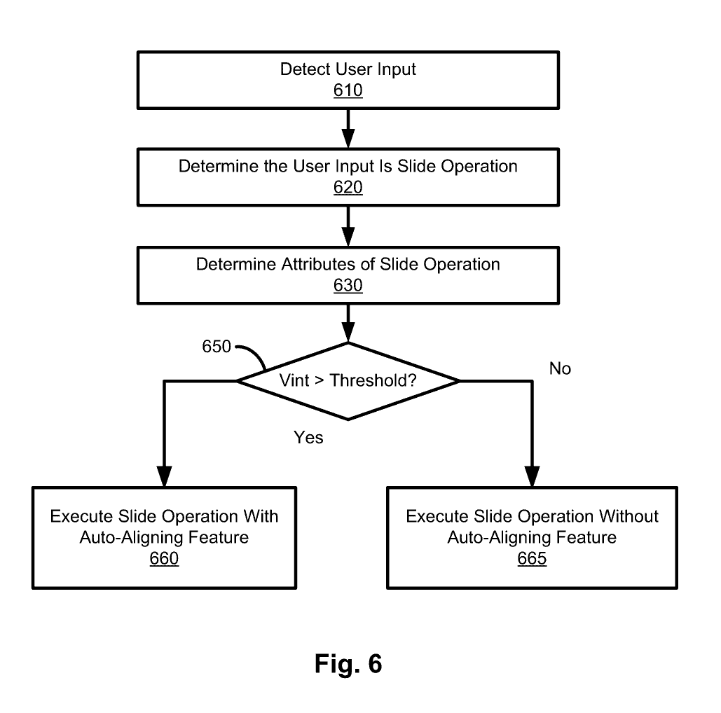

FIG. 6 illustrates an example process of determining whether to enable an auto-aligning feature for a slide operation according to one embodiment. In the embodiment illustrated in FIG. 6, the user input is a slide operation applied to a content panel. The steps in FIG. 6 can be performed by a client device 104. In other embodiments, some or all of the steps may be performed by other entities. In addition, some embodiments may perform the steps in parallel, perform the steps in different orders, or perform different steps.

The client device detects 610 a user input. The input detection module 330 of the client device 104 receives an input signal from the input device to detect the user input. In addition, the input detection module 330 determines a type of the user input and attributes associated with the user input. In one example, the input detection module 330 determines 620 the user input is a slide operation, and determines 630 attributes (e.g., velocity and direction) associated with the slide operation. The input detection module 330 determines 650 whether the velocity (Vint) of a slide operation is greater than a predetermined threshold velocity.

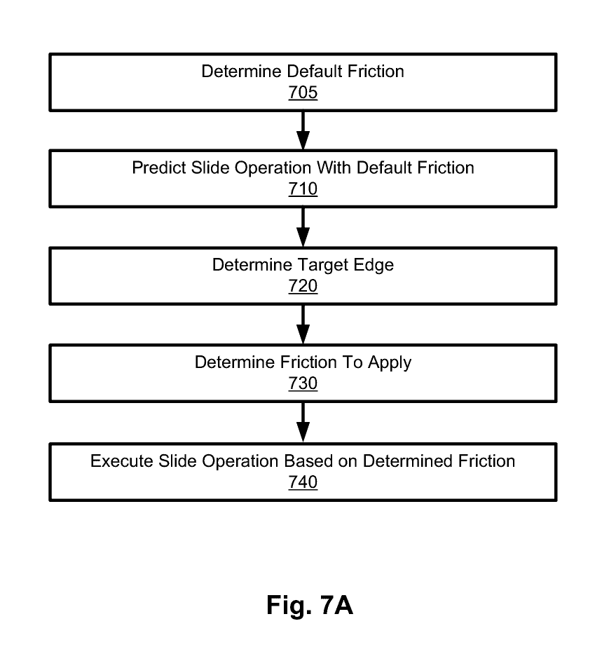

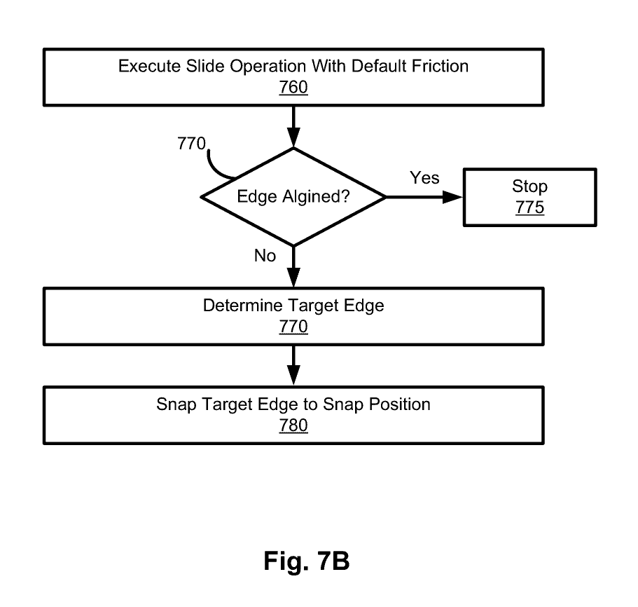

Responsive to the velocity of the slide operation being greater than the velocity threshold, the slide execution module 432 executes 660 the slide operation with the auto-aligning feature, described in detail with respect to FIG. 7A and FIG. 7B. Responsive to the velocity of the slide operation being less than or equal to the velocity threshold, the slide execution module executes 665 the slide operation without the auto-aligning feature. If the auto-aligning feature is disabled, the slide execution module 432 determines default friction based at least in part on the velocity of the slide operation and executes the slide operation with the default friction.

FIG. 7A illustrates one example process of executing a slide operation with auto-aligning feature according to one embodiment. The steps in FIG. 7A can be performed by a client device 104. The client device 104 executes the slide operation with the auto-aligning feature with friction determined based on a prediction of the slide operation without the auto-aligning feature (or with default friction applied). The client device 104 executes the slide operation with the determined friction such that an edge of a content item is smoothly aligned with the snap position. In other embodiments, some or all of the steps may be performed by other entities. In addition, some embodiments may perform the steps in parallel, perform the steps in different orders, or perform different steps.

The slide execution module 432 determines 705 default friction for predicting the slide operation without the auto-aligning feature. The default friction can be obtained based on, for example, the velocity of the slide operation.

The slide execution module 432 predicts 710 a slide operation with the default friction (or without auto-aligning feature).

The slide execution module 432 determines 720 a target edge (e.g., an edge of the content item to be aligned with the snap position) based on the prediction of the slide operation with the default friction. In one aspect, the target edge is an edge closer to the snap location when the predicted slide operation with the default friction is ended. In another aspect, the target edge is an edge appearing before or after the snap position in the sliding direction of the content panel when the predicted slide operation with the default friction is ended.

The slide execution module 432 determines 730 friction to be applied to the slide operation for smooth sliding of the content panel to the determined edge. For example, the slide execution module 432 determines friction to be applied to the slide operation based on the current position of the display region, velocity, and the remaining distance between the target edge and the snap position. The slide execution module 432 executes 740 the slide operation with the determined friction to perform auto-aligning feature.

FIG. 7B illustrates one example process of executing a slide operation with auto-aligning feature according to another embodiment. The steps in FIG. 7B can be performed by a client device 104. The client device 104 executes the slide operation with the auto-aligning feature by performing the slide operation with default friction, and shifting the content panel when the slide operation stops. The slide execution module 432 determines default friction to apply to the slide operation and executes 760 the slide operation with the default friction (or without auto-aligning feature). The default friction can be obtained on the velocity of the slide operation. After the slide operation with the default friction stops, the slide execution module 432 determines 770 whether any of the edges of the content items is aligned with the snap position. Responsive to an edge of a content item being aligned with the snap position, the slide execution module 432 stops 775 the slide operation because auto-aligning feature is not needed. Responsive to an edge of a content item being misaligned with the snap position, the slide execution module 432 determines 770 a target edge (e.g., an edge of the content item to be aligned with the snap position). The slide execution module snaps 780 the determined target edge to the snap position. Specifically, the slide execution module shifts the content panel such that the determined target edge is aligned with the snap position.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

What is claimed is:

1. A computer-implemented method for presenting a digital magazine on a client device, the method comprising:
receiving a slide operation with a velocity from a user of the client device to slide a content panel being displayed on the client device, the content panel including a plurality of content items and two spatially neighboring content items of the plurality of content items sharing an edge, the plurality of the content items being displaced according to a page layout;
comparing the velocity of the slide operation with a velocity threshold; and
responsive to the velocity of the slide operation exceeding the velocity threshold, aligning a target edge between two content items with a snap position by automatically applying friction to the slide operation, the snap position representing a predetermined position of the content panel after the slide operation.

2. The method of claim 1, wherein automatically applying the friction to the slide operation comprises:
determining default friction of the slide operation based on the velocity of the slide operation; and
determining the target edge from a plurality of edges separating the plurality of content items in response to the slide operation according to the default friction.

3. The method of claim 1, wherein automatically applying the friction to the slide operation comprises:
determining the friction to apply to the slide operation to align the target edge to a snap position; and
executing the slide operation according to the determined friction.

4. The method of claim 1, further comprising:
determining a distance between the target edge and the snap position; and
shifting the content panel by the determined distance to align the target edge with the snap position.

5. The method of claim 2, wherein determining the target edge comprises:
predicting an intermediate position of the content panel based on the default friction of the slide operation; and
selecting an edge as the target edge from the edges separating the plurality of content items based on the intermediate position of the content panel, wherein the selected edge is closer to the snap position than other edges separating the content items.

6. The method of claim 2, wherein determining the target edge further comprises:
predicting an intermediate position of the content panel based on the default friction of the slide operation; and
identifying two edges from the edges separating the plurality of content items based on the intermediate position of the content panel, one of the two identified edges being above the snap position and the other identified edge being below the snap position in the page layout.

7. The method of claim 6, further comprising:
determining a distance between each of the identified edges and the snap position; and
selecting one of the identified edges as the target edge, wherein the selected edge has a shorter distance from the snap position than the distance between the other of the identified edges and the snap position.

8. The method of claim 3, wherein executing the slide operation according to the determined friction comprises:
applying the determined friction to the slide operation before the slide operation stops based on the default friction; and
automatically aligning the target edge with the snap position.

9. The method of claim 1, further comprising:
generating an updated content panel, the updated content panel having the plurality of content items being displayed with the target edge being aligned with the snap position; and
displaying the updated content panel to the user of the client device.

10. The method of claim 1, further comprising:
generating an updated content panel in response to a subsequent slide operation to the content panel; and
displaying the updated content panel to the user of the client device.

11. A non-transitory computer-readable storage medium storing executable computer program instructions for presenting a digital magazine on a client device, the computer program instructions comprising instructions for:
receiving a slide operation with a velocity from a user of the client device to slide a content panel being displayed on the client device, the content panel including a plurality of content items and two spatially neighboring content items of the plurality of content items sharing an edge, the plurality of the content items being displaced according to a page layout;
comparing the velocity of the slide operation with a velocity threshold; and
responsive to the velocity of the slide operation exceeding the velocity threshold, aligning a target edge between two content items with a snap position by automatically applying friction to the slide operation, the snap position representing a predetermined position of the content panel after the slide operation.

12. The computer-readable storage medium of claim 11, wherein the computer program instructions for automatically applying the friction to the slide operation comprise instructions for:
determining default friction of the slide operation based on the velocity of the slide operation; and
determining the target edge from a plurality of edges separating the plurality of content items in response to the slide operation according to the default friction.

13. The computer-readable storage medium of claim 11, wherein the computer program instructions for automatically applying the friction to the slide operation comprise instructions for:
determining the friction to apply to the slide operation to align the target edge to a snap position; and
executing the slide operation according to the determined friction.

14. The computer-readable storage medium of claim 11, further comprising computer program instructions for:
determining a distance between the target edge and the snap position; and
shifting the content panel by the determined distance to align the target edge with the snap position.

15. The computer-readable storage medium of claim 12, wherein the computer program instructions for determining the target edge comprise instructions for:
predicting an intermediate position of the content panel based on the default friction of the slide operation; and
selecting an edge as the target edge from the edges separating the plurality of content items based on the intermediate position of the content panel, wherein the selected edge is closer to the snap position than other edges separating the content items.

16. The computer-readable storage medium of claim 12, wherein the computer program instructions for determining the target edge further comprise instructions for:
predicting an intermediate position of the content panel based on the default friction of the slide operation; and
identifying two edges from the edges separating the plurality of content items based on the intermediate position of the content panel, one of the two identified edges being above the snap position and the other identified edge being below the snap position in the page layout.

17. The computer-readable storage medium of claim 16, further comprising computer program instructions for:
determining a distance between each of the identified edges and the snap position; and
selecting one of the identified edges as the target edge, wherein the selected edge has a shorter distance from the snap position than the distance between the other of the identified edges and the snap position.

18. The computer-readable storage medium of claim 13, wherein the computer program instructions for executing the slide operation according to the determined friction comprise instructions for:
applying the determined friction to the slide operation before the slide operation stops based on the default friction; and
automatically aligning the target edge with the snap position.

19. The computer-readable storage medium of claim 11, further comprising computer program instructions for:
generating an updated content panel, the updated content panel having the plurality of content items being displayed with the target edge being aligned with the snap position; and
displaying the updated content panel to the user of the client device.

20. The computer-readable storage medium of claim 11, further comprising computer program instructions for:
generating an updated content panel in response to a subsequent slide operation to the content panel; and
displaying the updated content panel to the user of the client device.
